(19) United States
(12) Patent Application Publication
(10) Pub. No.: US 2008/0120246 A1
(43) Pub. Date: May 22, 2008

(54) SYSTEM AND METHOD FOR TRADING FINANCIAL INSTRUMENTS ASSOCIATED WITH FUTURE EVENTS

(76) Inventors: Brian Sopinsky, Lafayette Hill, PA (US); Todd Mitchell Simkin, Wynnewood, PA (US)

Correspondence Address: FISH & RICHARDSON P.C., P.O. BOX 1022, MINNEAPOLIS, MN, 55440-1022, US

(21) Appl. No.: 11/560,797

(22) Filed: Nov. 16, 2006

(51) Int. Cl. G06Q 40/00

(52) U.S. Cl. 705/36 R; 705/37; 705/35

(57) ABSTRACT

A financial instrument, and methods and systems for trading the financial instrument are provided. In one method, a trader enters into a futures contract for at least one share of a non-public company at a time prior to an initial public offering of stock of the company at an expected future price of the stock at a future time. The futures contract also provides for being settled at an actual future market based price at the future time after the non-public company becomes public through the initial public offering.

### FIELD OF THE INVENTION

The present invention relates to the field of financial instruments, and in particular, to financial instruments associated with one or more future events, such as the initial public offering of stock of a company, and a system and method for trading such instruments.

### BACKGROUND OF THE INVENTION

Initial public offerings (“IPOs”) can pose several challenges for investors. When a stock is first offered on the open market following an IPO, there sometimes is a substantial run up in price within hours or even minutes of the start of trading due to intense public interest in the new issue. Typically, investors can only benefit from this price “pop” if they were fortunate enough to obtain an allocation of shares in the IPO.

On the other hand, IPOs run the risk of having the price of their stock drop once trading begins. Investors who obtained an allocation of shares in the IPO currently have no means of protection against such price decreases.

### SUMMARY OF THE INVENTION

Embodiments of the invention involve a financial instrument comprising a futures contract in which a buyer purchases from a seller a contract having one or more terms derived from one or more future events associated with one or more underlying assets. For example, such a futures contract may be for a number of shares of stock to be issued by a non-public company at a given price per share, with the contract to be settled at a future market-based price at a future time after the company's IPO.

This invention provides several advantages to an investor. For example, through such a futures contract, an investor who did not receive an allocation of any IPO shares or who did not receive a sufficient allocation can nevertheless participate in post-IPO price increases of the underlying stock to the extent of the allocation that was desired. On the other hand, investors who participated in the IPO may use this futures contract to hedge against price drops in post-IPO trading. In addition, an investor who received in IPO allocation of stock can use the futures contract to capture profit from a post-IPO price increase without selling any allocated shares.

In other embodiments, this futures contract could be used to minimize risk prior to an IPO, e.g., to hedge bids in a Dutch auction IPO, to reduce the risk of not receiving an allocation or paying a higher price relative to others. For example, a founder or early investor who has private shares of a non-public company which will convert into publicly tradable shares at the time of an IPO may have an interest in protecting the price at which those shares are converted. As such, he or she may be concerned that the price not drop below a certain amount. Such a founder or early investor could sell this futures contract to lock in a price for the IPO, thus mitigating his or her risk.

In another example, where an interested buyer of an IPO has an off-setting risk position in other stocks or index products in the same industry, that buyer may be counting on receiving an allocation of shares from the IPO to offset, or hedge, that risk (for instance, there may be a new oil service company issuing shares, and the customer, in anticipation of receiving shares that he or she believes will outperform the market, buys puts on the oil service index (OSX)). If that interested buyer then does not receive the shares, the same risk mitigation can be replicated through a futures contract according to this invention.

Other embodiments of the invention involve methods and systems for trading the new financial instrument.

One exemplary embodiment of the invention involves a method for trading financial instruments. According to the method, a futures contract is entered into for at least one unit of an asset at a first price and at a time prior to a first time, wherein the first time is characterized by the start of sales of the asset into a market in which the price of the asset will be determined, at least in part, by market forces. Also, the futures contract describes a second time at which the contract will be settled that occurs after the first time and describes a second price at which the futures contract will be settled at the second time.

Another exemplary embodiment of this method involves settling the futures contract at the second price at the second time.

According to another exemplary embodiment of this method, the asset comprises stock of a non-public company, and the first time is characterized by an initial public offering of the stock of the company.

In another exemplary embodiment of this method, the asset comprises real property.

Another exemplary embodiment of the invention involves another method for obtaining an economic interest in stock of a non-public company. According to this method, a futures contract is entered for at least one share of stock of a non-public company at a first price and at a time prior to a first time, wherein the first time is characterized by an initial public offering of the stock of the company. Also, the contract describes a second time occurring after the first time at which the contract will be settled and describes a second price at which the contract will be settled at the second time.

According exemplary embodiment of this method also involves settling the futures contract at the second price at the second time.

According to another exemplary embodiment of this method, the contract describes the second time as a date and a time of day.

In another exemplary embodiment of this method, entering into the futures contract comprises purchasing the futures contract from a seller.

In another exemplary embodiment of this method, entering into the futures contract comprises selling the futures contract to a buyer.

In another exemplary embodiment of this method, entering into the futures contract includes providing margin.

According to another exemplary embodiment of this method, the second price comprises a market price for the stock at the second time.

According to another exemplary embodiment of this method, the second price comprises a volume weighted average price of a predefined time period following the first time.

In another exemplary embodiment of this method, the first price comprises an expected total market capitalization of the company at a third time divided by the total number of shares of the company outstanding at the third time, wherein the third time occurs after the first time. Also, the second price comprises an actual total market capitalization of the company at the third time divided by the total number of shares of the company outstanding at the third time.

Another exemplary embodiment of the invention involves a computer implemented method for trading financial instruments. First, a proposal for a futures contract is placed at an electronic trading system, wherein the proposed contract is for at least one share of stock of a non-public company and the proposed contract describes a first price and a first time at which the contract would be entered, wherein the first time is scheduled to occur prior to an initial public offering of the stock of the company, and wherein the proposed contract describes a second time scheduled to occur after the initial public offering at which the contract would be settled and describes a second price at which the contract would be settled at the second time. Next, a futures contract is entered based on the proposal.

An exemplary embodiment of this method also involves settling the futures contract at the second price at the second time.

Another exemplary embodiment of the invention involves a financial instrument. The financial instrument comprises a futures contract for at least one unit of an asset. The futures contract describes a first price and a first time at which the futures contract is to be entered, wherein the first time is scheduled to occur prior to a start of sales of the asset into a market in which the price of the asset will be determined, at least in part, by market forces. Also, the futures contract describes a second price and second time at which the futures contract is to be settled, wherein the second time is scheduled to occur after the start of sales of the asset.

In an exemplary embodiment of this financial instrument, the asset comprises stock of a non-public company, and the first time is scheduled to occur prior to an initial public offering of the stock of the company.

In another exemplary embodiment of this financial instrument, the asset comprises real property.

Another exemplary embodiment of the invention involves a financial instrument. This financial instrument comprises a futures contract for at least one share of stock of a non-public company. The futures contract describes a first price and a first time at which the futures contract is to be entered, wherein the first time is scheduled to occur prior to an initial public offering of the stock of the company. Also, the futures contract describes a second price and a second time at which the futures contract is to be settled, wherein the second time is scheduled to occur after the initial public offering.

In an exemplary embodiment of this financial instrument, the contract describes the second time as a date and a time of day.

In another exemplary embodiment of this financial instrument, the contract describes a second price that comprises a market price for the stock at the second time.

According to another exemplary embodiment of this financial instrument, the contract describes a second price that comprises a volume weighted average price during a predefined time period following the first time.

Additional aspects of the present invention will be apparent in view of the description which follows.

### DESCRIPTION OF DRAWINGS

The invention is illustrated in the figures of the accompanying drawings, which are meant to be exemplary and not limiting, and in which like references are intended to refer to like or corresponding parts.

FIG. 1 is a flow chart showing an operative embodiment of the present invention;

FIG. 2 is a flow chart showing another operative embodiment of the present invention;

FIG. 3 is a block diagram of an embodiment of the system of the present invention showing the environment in which the system operates; and

FIG. 4 is a flow chart showing another operative embodiment of the present invention.

Like reference symbols in the various drawings indicate like elements.

### DETAILED DESCRIPTION

Embodiments of the invention involve a financial instrument having one or more terms derived from one or more future events, such as the starting of sales on a future date of an asset into a market in which the price of the asset will be determined, at least in part, by market forces. The asset may include any asset whose price may be determined by market forces (e.g., supply and demand) such as, for example, the stock of a company and real estate. This financial instrument of the invention may be referred to as the “Starting of Sales of a Market Priced Asset Instrument” or SSMPA Instrument.

The SSMPA Instrument may comprise a futures contract whose terms may be defined by the parties to the contract (e.g., buyer or seller), a third party (e.g., a broker) or a financial instrument marketplace in which the SSMPA Instrument is traded, or some combination thereof. It is understood that the term “financial instrument marketplace” is construed broadly herein, to include one or more of the following: (i) any U.S. or foreign exchange, including without limitation, any organization, association or group of persons, whether incorporated or unincorporated, that constitute, maintain or provide a marketplace or facilities for bringing together buyers and sellers of securities, futures and/or other financial instruments, for bringing together orders for securities, futures and/or other financial instruments of multiple buyers and sellers, or for otherwise performing with respect to securities, futures and/or other financial instruments the functions commonly performed by a stock exchange, commodity exchange, trading center, alternative trading system, trade reporting system, alternative display facility, automated trading center, electronic communications network or other similar facility as those terms are respectively generally understood; (ii) any U.S. or foreign quotation and trade reporting system or any other similar facility or market center where orders to buy and sell securities, futures, and/or other financial instruments interact with each other, (iii) any market facility maintained by any such exchange, quotation system, trading center, alternative trading system, alternatively display facility, automated trading center, electronic communications network or other facility; and (iv) any U.S. or foreign over-the-counter market, including, without limitation, any in-person, telephone, computer or other electronic network that connect buyers and sellers of securities, futures and/or other financial instruments.

The SSMPA Instrument may comprise a futures contract that describes (a) the number of units of the asset covered by the contract, (b) a price Fₚ at which the contract is entered into, (c) a time Fₜ at which the contract is entered into which occurs prior to the start of sales of the asset into a market in which the price of the asset will be determined, at least in part, by market forces, (d) a price Sₚ at which the contract is to be settled, and (e) a time Sₜ at which the contract is to be settled and which occurs after the starting of sales of the asset into a market in which the price of the asset will be determined, at least in part, by market forces. This futures contract may be standardized so as to be capable of being traded in a financial instrument marketplace.

The SSMPA Instrument may describe the prices Fₚ and Sₚ in a number of ways. For example, they may be defined as specific prices (e.g., $100) or the SSMPA Instrument may provide a description of how the price is to be determined.

The times Fₜ and Sₜ may refer to a date or a date and time of day. The SSMPA Instrument may describe the times Fₜ and Sₜ in a number of ways. For example, these times may be defined as a specific date or specific date and time or the SSMPA Instrument may provide a description of how the time is to be determined. As an example of the latter, the SSMPA Instrument may describe Sₜ as a date or time at which a given event occurs (e.g., X number of units of the market priced asset having been sold) following the date on which sales of the market priced asset start.

In an embodiment of the invention, the SSMPA Instrument comprises a futures contract having one or more terms derived from an initial public offering (“IPO”) of the securities of a non-public company scheduled for a future date. Such a financial instrument is referred to below as an “IPO Future” or an “IPO Futures Contract” (“IPOF”). The description below may utilize this term in describing an exemplary embodiment of the invention, but it is understood that the invention may be utilized for any useful security, as understood in the art.

The IPOF may describe (a) the number of shares covered by the IPOF, (b) a price Fₚ at which the contract is entered into, (c) a time Fₜ at which the contract is entered into which occurs prior to the IPO, (d) a price Sₚ at which the contract is to be settled, and (e) a time Sₜ at which the contract is to be settled which occurs after the IPO.

The IPOF may describe the prices Fₚ and Sₚ as specific prices or the IPOF may provide descriptions of how these prices may be determined. For example, the IPOF may describe Sₚ as the market price of the underlying stock at the time of settlement Sₜ or a derivative thereof, e.g., the volume weighted average price (“VWAP”) during a period of time following the IPO and prior to the time of settlement Sₜ. In another example, the IPOF may describe Fₚ and Sₚ in relation to expected and actual market capitalizations. For instance, the IPOF may describe Fₚ and Sₚ as follows:

Fₚ=Expected Cap/N; and

Sₚ=Actual Cap/N

where Expected Cap is an expected total market capitalization of the non-public company after a given time period (e.g., 5 days) following the IPO, N is the total number of shares of the company outstanding at the time of the elapsing of the given time period following the IPO, and Actual Cap is the actual total market capitalization of the non-public company after the given time period following the IPO.

Also, the IPOF may describe the times Fₜ and Sₜ as specific dates or specific dates and times or the IPOF may provide descriptions of how these times may be determined. As an example of the latter, the IPOF may describe the settlement time Sₜ as X minutes, or X hours, or X days after the start of trading after the IPO.

In another embodiment of the invention, the SSMPA Instrument comprises a futures contract having one or more terms derived from the starting of sales of real property into a market in which the price of the real property will be determined, at least in part, by market forces. This starting of sales of real property may be, for example, the placing of one or more existing properties for sale on the public market or the opening for public sale of one or more condominium units in a newly constructed or newly renovated building.

This real estate futures contract (“REF”) may describe (a) the number of units of real property covered (e.g., the number of condominium units), (b) price Fₚ at which the contract is entered into, (b) a time Fₜ at which the contract is entered into which occurs prior to the starting of sales, (c) a price Sₚ at which the contract is to be settled, and (d) a time Sₜ at which the contract is to be settled which occurs after the starting of sales. The REF may describe the prices Fₚ and Sₚ as specific prices or the REF may provide descriptions of how these prices may be determined. Also, the REF may describe the times Fₜ and Sₜ a specific dates or specific dates and times or the REF may provide descriptions of how these times may be determined.

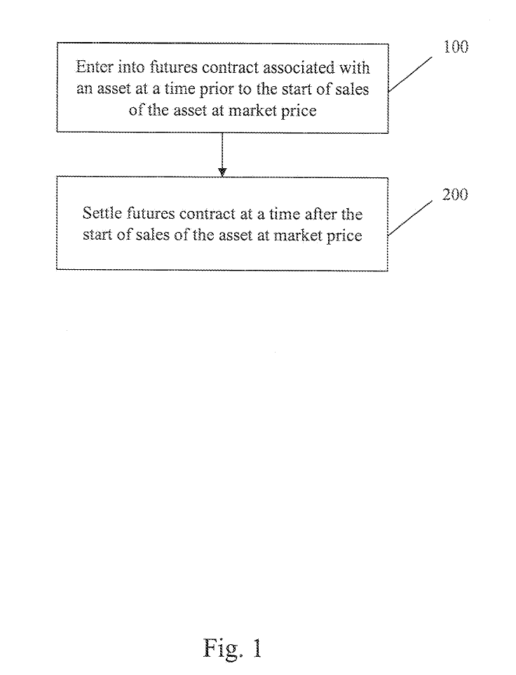

Embodiments of the invention also include methods for trading the financial instruments discussed above. One such method is depicted in the flow chart of FIG. 1. First, as shown in block 100, a party enters into a futures contract for at least one unit of an asset (e.g., stock or real property) at a price Fₚ and at a time Fₜ that occurs prior to the starting of sales of the asset into a market in which the price of the asset will be determined, at least in part, by market forces. As discussed above, the futures contract also describes a price Sₚ and time Sₜ at which the futures contract will be settled, where Sₜ is scheduled to occur some time after the start of sales mentioned above. For example, the operations represented in block 100 may be accomplished by one party buying or selling a futures contract as described above to or from another party via a financial instrument marketplace.

Next, at a time Sₜ that occurs after the starting of sales, the party settles the futures contract at a price Sₜ, as shown in block 200. For example, the operations represented in block 200 may be accomplished when the futures contract is settled according to the rules and procedures of a financial instrument marketplace.

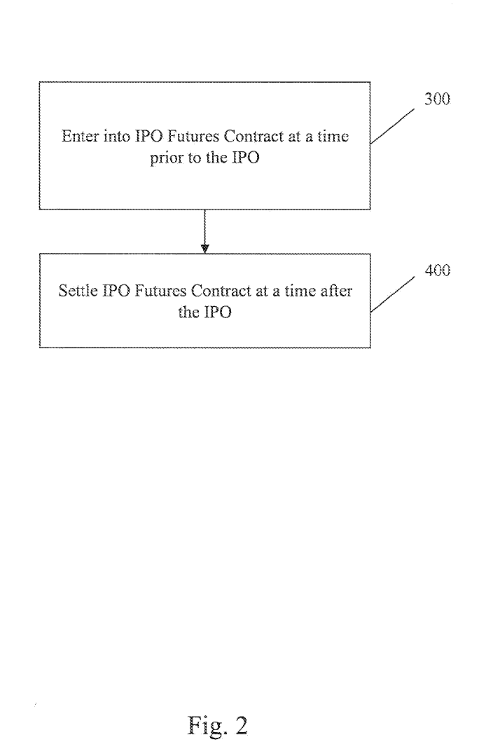

FIG. 2 is a flow chart showing another method of the invention. First, a party enters into an IPOF at a time prior to an IPO, as shown in block 300. For example, the party may be a buyer who purchases an IPOF from a seller through a financial instrument marketplace or a seller who sells an IPOF to a buyer through a financial instrument marketplace. The IPOF may be for at least one share of stock at a price Fₚ and the party may enter into the futures contract at a time Fₜ that occurs prior to the IPO (e.g., after the filing of the registration statement for the IPO and before the date and time of the IPO). The price Fₚ may be determined in a number of ways. For example, Fₚ may be negotiated by the buyer and seller, directly or through an intermediary, such as a broker, or Fₚ may be determined through the matching by a financial instrument marketplace of a bid to buy an IPOF from a buyer with an offer to sell and IPOF from a seller from a group of bids and offers submitted to a financial instrument marketplace from various buyers and sellers. As discussed above, the IPOF also describes a price Sₚ and time Sₜ at which the IPOF is to be settled, where Sₜ is scheduled to occur some time after the IPO. As is known in the art, parties may be required to provide margin prior to entering into an IPO Futures Contract.

Next, the party settles the IPOF at a time Sₜ occurring after the time of the IPO at a price Sₚ, as shown in block 400. For example, the operations represented in block 400 may be accomplished when the IPOF is settled according to the rules and procedures of a financial instrument marketplace. At the settlement date and time Sₜ, if the final settlement price Sₚ is less than the future price Fₚ specified in the contract, then the seller receives Fₚ−Fₚ (plus nay margin held), and the buyer pays Fₚ−Sₚ (less any margin held). If Sₚ=Fₚ, then margin payments are returned to both buyer and seller. If Sₚ is greater than Fₚ, then the buyer receives Sₚ−Fₚ (plus any margin held) and the seller pays Sₚ−Fₚ (less any margin held).

It should be noted that if the IPO is withdrawn or does not occur within a predetermined period of time, the IPO Future is automatically terminated and margin payments are returned to both buyer and seller.

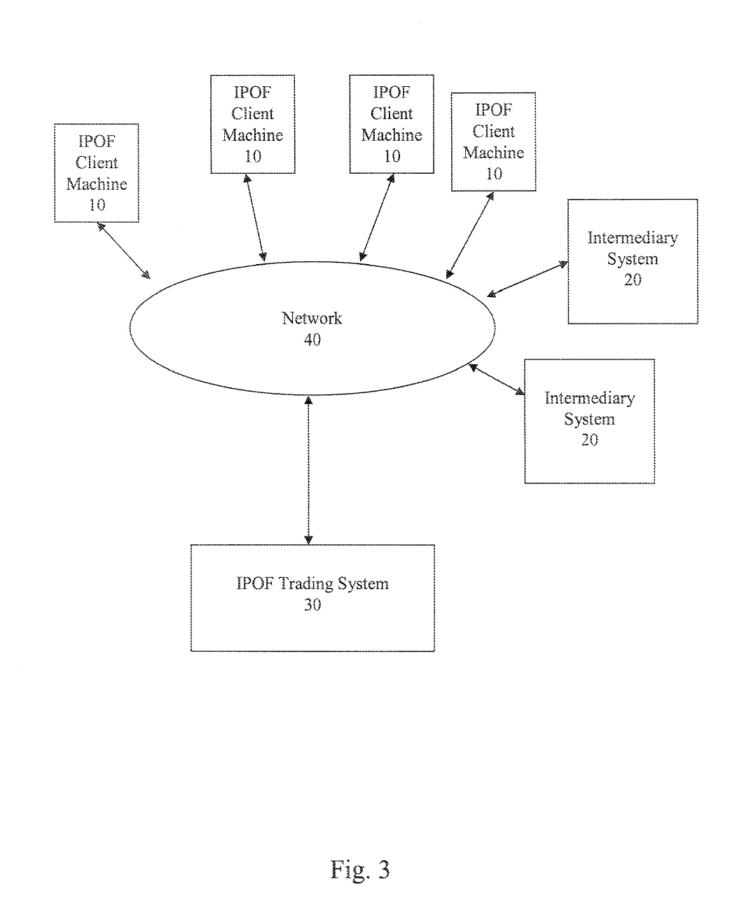

As mentioned above, the SSMPA Instrument may comprise a futures contract that may be traded in an electronic trading system, such as those mentioned above in connection with a financial instrument marketplace. FIG. 3 presents a diagram showing an embodiment of the system of the present invention, where an embodiment of the SSMPA Instrument, e.g., an IPO Futures Contract, is traded electronically. Traders (e.g., buyers and sellers) operate IPOF client machines 10 to interact with IPOF intermediary systems 20 or IPOF Trading System 30 in order to place orders to buy or sell IPO Futures. IPOF client machines 10 may comprise any computer capable of receiving data from and outputting data to a user and also transmitting data to and receiving data from other computers. As a non-limiting example, IPOF client machines 10 may comprise PCs or PDAs with programming code which when executed enables the PCs or PDAs to interact with a user (e.g., via a GUI and input devices, such as a mouse and keyboard or stylus) and to transmit and receive data via wired or wireless network connections.

The IPOF clients 10 communicate with IPOF intermediary systems 20 and IPOF Trading System 30 via network 40. Network 40 may comprise any communication path through which computers can communicate with each other, such as, for example, a LAN, a WAN, a public network (e.g., the Internet), a private network (e.g., leased lines), or a hybrid thereof (e.g., VPN). Also, although network 40 is shown in FIG. 1 as a single network, it should be understood that network 40 may comprise a plurality of networks in communication with each other.

Some traders, such as institutional investors or brokers trading for their own account, may submit IPO Futures orders directly to IPOF Trading System 30. Traders who cannot do so (e.g., due to securities laws and regulations) may utilize the services of an intermediary (e.g., a broker) to submit IPO Futures orders to IPOF Trading System 30 on their behalf. Such intermediaries operate intermediary systems 20 to receive orders from traders and place those orders with IPOF Trading System 30 and to receive data from IPOF Trading System 30 regarding settled trades and pass that data on to the traders at IPOF clients 10.

In this exemplary embodiment, IPOF Trading System 30 comprises one or more computers having software which, when executed, enables the IPOF Trading System 30 to perform the functions described below. IPOF Trading System 30 establishes the IPO Futures Contracts that may be traded based on information received from underwriters or publicly available materials regarding pending IPOs. IPOF Trading System 30 then receives orders to buy or sell such IPO Futures via network 40 from traders at IPOF clients 10 directly or indirectly through intermediary systems 20. IPOF Trading System 30 then processes these orders by, for example, matching orders from buyers with corresponding orders from sellers. IPOF Trading System 30 also tracks the margin of each trader, which may be held in escrow by a clearing firm, notifies each trader via messages sent to the trader's IPOF client 10 of changes in the trader's margin (e.g., due to fluctuations in the price of the trader's contracts), and alerts traders when margin levels fall below minimum levels.

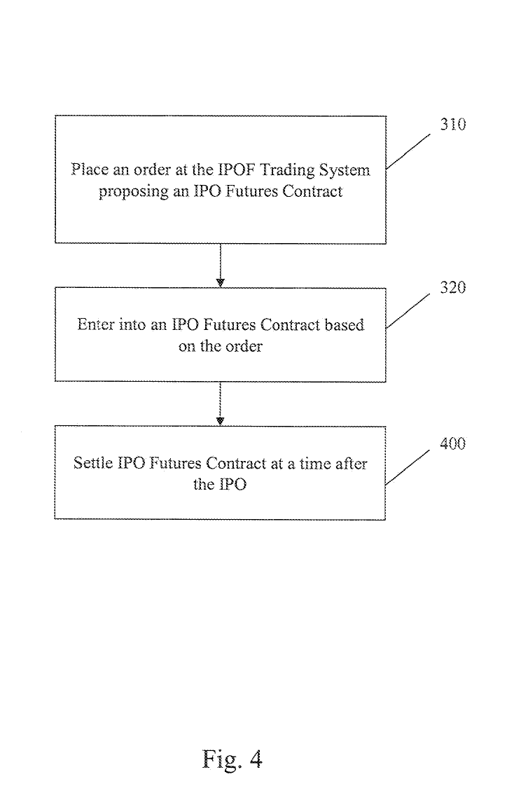

Another embodiment of the method of trading involving the IPO Futures discussed above in connection with the flow chart of FIG. 2 may be described in relation to the system shown in FIG. 3. As discussed above in connection with FIG. 2, the method begins when a trader enters into an IPO Futures Contract at a time prior to the IPO, as represented in block 300. One way in which this may be accomplished is shown in the flow chart of FIG. 4.

The trader places an order at IPOF Trading System 30, either directly or through an intermediary broker, for a proposed IPO Futures Contract, as represented in block 310. As a non-limiting example, prior to the start of a trading day, and possibly at certain update periods during the trading day, the trader's IPOF client machine 10 may receive data from IPOF Trading System 30 describing the market in IPO Futures available for trading at IPOF Trading System 30. For instance, such data may identify each different type (e.g., the company associated with each future) of IPO Future that can be traded at IPOF Trading System 30, as well as the terms of each and what may be specified of those terms. For example, for one IPO Future, the final settlement price Sₚ and the settlement date and time Sₜ may be predefined as the market price of the underlying stock at the close of the first day of trading. For another IPO Future, one or both of the final settlement price Sₚ and the settlement date and time Sₜ may be user selectable from a set of predefined choices (e.g., final settlement price Sₚ may be either the market price at the settlement date and time or VWAP calculated for the trading day on the settlement date up to the settlement time, and settlement date and time may be the first day of trading and 5 minutes, 15 minutes or 30 minutes after the start of trading on the that day).

Using this data received from IPOF Trading System 30, the trader may interact with the IPOF Client Machine 10 in order to provide the terms for the proposed IPO Futures Contract. The trader's proposal is then transmitted by the IPOF Client 10 via Network 40 either directly to IPOF Trading System 30 or indirectly to IPOF Trading System 30 via Intermediary System 20.

Next, the trader enters into an IPO Futures Contract based on the order, as represented in block 320. Upon receiving the trader's order with the proposed contract terms, IPOF Trading System 30 attempts to match it with a corresponding proposal from another trader. For example, if Trader A submitted a proposal to buy an IPO Future for 500 shares of Company X at $25 to be settled at VWAP after 10 minutes on the first day of trading and Trader B had previously submitted a proposal to sell an IPO Future with the same terms, then the proposals would be considered a match. Depending on the rules under which IPOF Trading System 30 operates, such a match may result in the counterparties automatically entering into an IPO Futures Contract for the proposed terms.

Next, the party settles the IPOF at a time Sₜ occurring after the time of the IPO at a price Sₚ, as shown in block 400 and discussed above.

It should be noted that data related to the trading of IPO Futures Contracts may be useful in setting the parameters for an IPO. As shown above, IPO Futures Contracts entered into prior to a company's IPO provide an indication of what the parties to those contracts believe the market price of the company's stock will be at some time after the IPO. Such data could be used by underwriters to set the price of the IPO. For example, U.S. patent application Ser. No. 11/557,847, filed on Nov. 8, 2006, entitled “Exchange-Based Auction for Offerings”, describes methods and systems for, among other things, determining the public offering price for offerings of securities, such as with an IPO. The data related to the trading of IPO Futures Contracts mentioned above could be utilized in the methods and systems described in the aforementioned application in determining the public offering price for an IPO.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modifications are intended to be included within the scope of the invention. Except to the extent necessary or inherent in the processes themselves, no particular order to steps or stages of methods or processes described in this disclosure, including the Figures, is implied. In many cases the order of process steps may be varied without changing the purpose, effect or import of the methods described.

What is claimed is:

1. A method for trading financial instruments, comprising:
entering into a futures contract for at least one unit of an asset at a first price and at a time prior to a first time, wherein the first time is characterized by the start of sales of the asset into a market in which the price of the asset will be determined, at least in part, by market forces; and
wherein the futures contract describes a second time at which the contract will be settled that occurs after the first time and describes a second price at which the futures contract will be settled at the second time.

2. The method of claim 1, further comprising settling the futures contract at the second price at the second time.

3. The method of claim 1, wherein the asset comprises stock of a non-public company; and
wherein the first time is characterized by an initial public offering of the stock of the company.

4. The method of claim 1, wherein the asset comprises real property.

5. A method for obtaining an economic interest in stock of a non-public company, comprising:
entering into a futures contract for at least one share of stock of a non-public company at a first price and at a time prior to a first time, wherein the first time is characterized by an initial public offering of the stock of the company;
wherein the contract describes a second time occurring after the first time at which the contract will be settled and describes a second price at which the contract will be settled at the second time.

6. The method of claim 5, further comprising settling the futures contract at the second price at the second time.

7. The method of claim 5, wherein the contract describes the second time as a date and a time of day.

8. The method of claim 5, wherein entering into the futures contract comprises purchasing the futures contract from a seller.

9. The method of claim 5, wherein entering into the futures contract comprises selling the futures contract to a buyer.

10. The method of claim 5, wherein entering into the futures contract includes providing margin.

11. The method of claim 5, wherein the second price comprises a market price for the stock at the second time.

12. The method of claim 5, wherein the second price comprises a volume weighted average price during a predefined time period following the first time.

13. The method of claim 5, wherein the first price comprises an expected total market capitalization of the company at a third time divided by the total number of shares of the company outstanding at the third time, wherein the third time occurs after the first time; and
wherein the second price comprises an actual total market capitalization of the company at the third time divided by the total number of shares of the company outstanding at the third time.

14. A computer implemented method for trading financial instruments, comprising:
placing a proposal for a futures contract at an electronic trading system, wherein the proposed contract is for at least one share of stock of a non-public company and the proposed contract describes a first price and a first time at which the contract would be entered, wherein the first time is scheduled to occur prior to an initial public offering of the stock of the company, and wherein the proposed contract describes a second time scheduled to occur after the initial public offering at which the contract would be settled and describes a second price at which the contract would be settled at the second time; and
entering into a futures contract based on the proposal.

15. The method of claim 14, further comprising settling the futures contract at the second price at the second time.

16. A financial instrument comprising:
a futures contract for at least one unit of an asset;
wherein the futures contract describes a first price and a first time at which the futures contract is to be entered, wherein the first time is scheduled to occur prior to a start of sales of the asset into a market in which the price of the asset will be determined, at least in part, by market forces; and
wherein the futures contract describes a second price and second time at which the futures contract is to be settled, wherein the second time is scheduled to occur after the start of sales.

17. The financial instrument of claim 16, wherein the asset comprises stock of a non-public company; and
wherein the first time is scheduled to occur prior to an initial public offering of the stock of the company.

18. The financial instrument of claim 16, wherein the asset comprises real property.

19. A financial instrument comprising:
a futures contract for at least one share of stock of a non-public company;
wherein the futures contract describes a first price and a first time at which the futures contract is to be entered, wherein the first time is scheduled to occur prior to an initial public offering of the stock of the company; and
wherein the futures contract describes a second price and a second time at which the futures contract is to be settled, wherein the second time is scheduled to occur after the initial public offering.

20. The financial instrument of claim 19, wherein the contract describes the second time as a date and a time of day.

21. The financial instrument of claim 19, wherein the contract describes a second price that comprises a market price for the stock at the second time.

22. The financial instrument of claim 19, wherein the contract describes a second price that comprises a volume weighted average price during a predefined time period following the first time.
